(19) United States
(12) Patent Application Publication
(10) Pub. No.: US 2024/0152698 A1
(43) Pub. Date: May 9, 2024

(54) DATA-DRIVEN NAMED ENTITY TYPE DISAMBIGUATION

(71) Applicant: International Business Machines Corporation, Armonk, NY (US)

(72) Inventors: Mohammed Fahd ALHAMID, Stouffville (CA); Stefano BRAGHIN, Dublin (IE); Jing Xin DUAN, Markham (CA); Mokhtar KANDIL, Toronto (CA); Youngja PARK, Princeton, NJ (US); Micha Gideon MOFFIE, Zichron Yaakov (IL)

(21) Appl. No.: 18/053,811

(22) Filed: Nov. 9, 2022

(51) Int. Cl. G06F 40/295; G06F 16/31; G06F 40/169; G06F 40/30; G06N 5/02

(52) U.S. Cl. CPC G06F 40/295; G06F 16/31; G06F 40/169; G06F 40/30; G06N 5/022

(57) ABSTRACT

An enhanced system and method are provided for data-driven named entity type disambiguation of one or more disclosed embodiments. A system and a non-limiting computer-implemented method provides named-entity type disambiguation; receiving an unstructured document, analyzing the document using a set of Named Entity Recognition (NER) annotators, each generating annotated entities. For each respective annotated entity an Entity Disambiguation Module resolves a target entity type when a mention was assigned multiple entity types by different NER annotators by leveraging domain knowledge to form a set of first resolved entities. An Annotation Ranker associates a computed score to each entity in the set of first resolved entities using information in a knowledge base. An Entity Consolidator resolves the set of first resolved entities to create a set of final entities using the associated computed score for each entity and information in the knowledge base, optimally identifying named entities from the unstructured document.

### BACKGROUND

The present invention relates to the data processing field, and more specifically, to a method and system for data-driven named entity type disambiguation.

The identification of named entities within unstructured data is a key component of several Artificial Intelligence (AI) tasks, such as document topic classification, information extraction, risk assessment, and more. The state of the art for Named Entity Recognition (NER) focuses on specific types, namely Person, Location, and Organization. This leaves several domain specific types untouched, such as the medical field, product shipping environment, and the like.

Current best practices focus on the creation of a large model performing NER for a specific domain, incorporating characteristics of the unstructured documents to be processed. This can improve precision for the specific domain, but generally requires the creation of a new model for a new domain, as currently available models perform poorly when applied to documents with different characteristics.

### SUMMARY

An enhanced system and method are provided for data-driven named entity type disambiguation of one or more disclosed embodiments. A non-limiting computer-implemented method provides named-entity type disambiguation; receiving an unstructured document provided as a user input to extract entities, leveraging domain knowledge to automatically identify characteristics of multiple entity types, enhancing entity type coverage, and providing results optimally identifying named entities from the unstructured document. A received document containing unstructured data is analyzed by a set of Named Entity Recognition (NER) annotators, each NER annotator generating annotated entities according to their respective different capabilities. For a respective annotated entity a target entity type is resolved, when a mention was assigned multiple entity types by different NER annotators, to form a set of first resolved entities. A computed score is associated to each entity in the set of first resolved entities using information in a knowledge base. The set of first resolved entities is resolved to create a set of final entities using the associated computed score for each entity and information in the knowledge base. The set of final entities is provided to the user.

Other disclosed embodiments include a system and computer program product for data-driven named entity type disambiguation implementing features of the above-disclosed method.

### BRIEF DESCRIPTION OF THE DRAWINGS

FIG. 1 is a block diagram of an example computer environment for use in conjunction with one or more embodiments for data-driven named entity type disambiguation;

FIG. 2 is a block diagram of an example system for data-driven named entity type disambiguation of one or more disclosed embodiments;

FIG. 3 is a flow chart illustrating example operations of data-driven named entity type disambiguation of one or more disclosed embodiments; and

FIG. 4 is a flow chart illustrating example system operations responsive to user feedback of one or more embodiments of data-driven named entity type disambiguation.

### DETAILED DESCRIPTION

In accordance with features of embodiments of the disclosure, an enhanced system and method are provided for data-driven named entity type disambiguation, receiving a document including unstructured data, provided as a user input and extracting entities from the document. A non-limiting computer implemented method comprises analyzing the received unstructured document using a set of Named Entity Recognition (NER) annotators, each generating annotated entities according to their respective different capabilities. An Entity Disambiguation Module resolves a target entity type for each respective annotated entity including multiple entity types. For example, when a mention. i.e., a specific named entity, was assigned multiple entity types by different NER annotators the Entity Disambiguation Module resolves the target entity type by leveraging domain knowledge to form a set of first resolved entities. For example, a specific named entity or mention, such as Harris, and assigned an entity type of PERSON and assigned an entity type of COMPANY is resolved by the Entity Disambiguation Module to harmonize the entity types of the NER annotators. An Annotation Ranker associates a computed score to each entity in the set of first resolved entities using information in a knowledge base. An Entity Consolidator coupled to the Annotation Ranker resolves the set of first resolved entities to create a set of final entities using the associated computed score for each entity and information in the knowledge base, optimally identifying named entities from the unstructured document.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

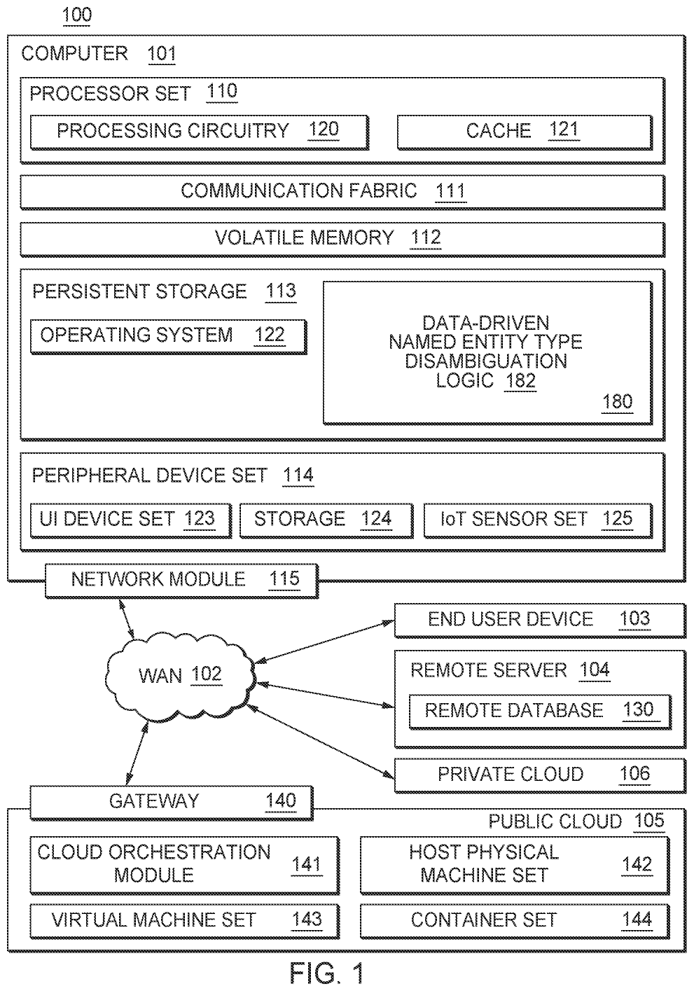

With reference now to FIG. 1, there is shown an example computing environment 100. Computing environment 100 contains an example of an environment for the execution of at least some of the computer code involved in performing inventive methods at block 180, such as Data-Driven Named Entity Type Disambiguation Logic 182. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

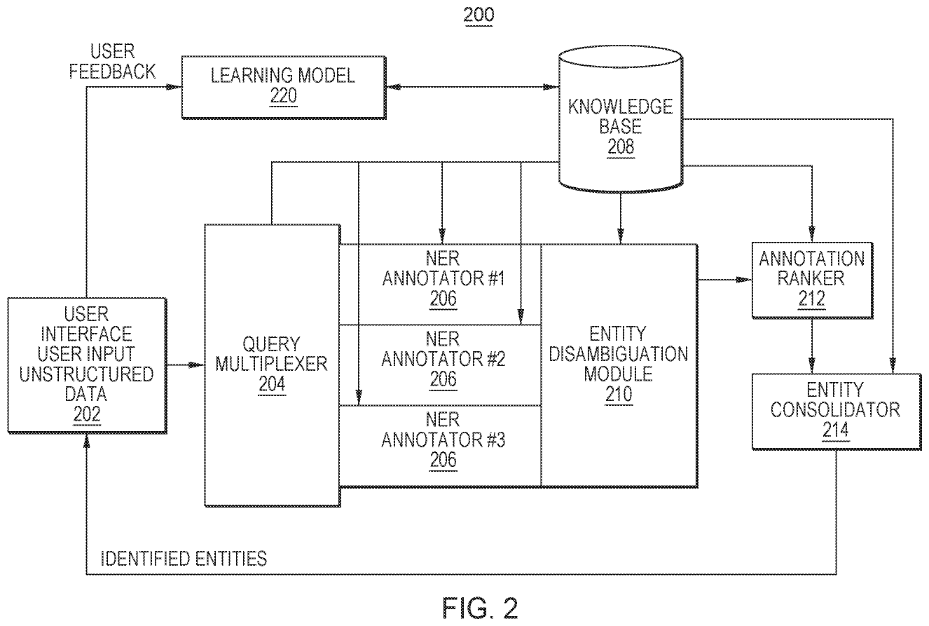

Referring now to FIG. 2, an example system 200 is shown for data-driven named entity type disambiguation of one or more disclosed embodiments. System 200 includes a user interface 202 for receiving a document containing unstructured data, such as a text document, Word document or Extensible Markup Language (XML) document. A user submits the document to the system 200, which extracts entities from the unstructured text data.

System 200 includes a query multiplexer 204 receiving the user entered document and providing a compatible input of the user entered document to each of a set of multiple Named Entity Recognition (NER) annotators 206, #1-3, as shown. The set of NER annotators 206 includes a selected number of NER annotators with three NER annotator 206 shown only as an illustrative example. Each NER annotator 206 is capable of generating annotated entities according to their respective different capabilities enabling a broad scope of entities supported by the system 200. In one embodiment, the NER annotators 206, #1-3 have overlapping capabilities including similar features and different capabilities, depending on requirements of system 200. For example, one of more of the NER annotators 206 includes algorithms or techniques for detecting medical terms, another for detecting names, another for detecting places. Multiple NER annotators 206 could be configured for the same task, while each using different NER techniques to do so. The multiple NER annotators 206 can include state of the art currently available algorithms and techniques and advantageously can be implemented and trained using different approaches, for example machine learning models and rule-based systems.

System 200 includes a knowledge base 208 used in conjunction with system components in accordance with the disclosed embodiments including an Entity Disambiguation Module 210, an Annotation Ranker 212, and an Entity Consolidator Consolidator 214. In one embodiment, the knowledge base 208 contains semantic specification of the capabilities of each available NER annotator 206 #1-3, and a set of weights associated to each entity-NER annotator pair. The knowledge base 208 contains a semantic hierarchy representing semantic relationship among the overall supported entity types, the specification of the merging and learning strategies to be deployed by the Entity Disambiguation Module 210, the Annotation Ranker 212, and the Entity Consolidator 214.

The Entity Disambiguation Module 210 resolves the target entity type when a mention or specific named entity was assigned multiple entity types by different NER annotators by, e.g., leveraging both external and internal knowledge. The leveraged external knowledge includes information of external knowledge base 208. The leveraged internal knowledge includes type specificity information for assigning entities and length of mention information. The leveraged external knowledge of external knowledge base 208 is used to map entities detected by the various NER annotators 206 #1-3, to a common set of entity types. For example, a first NER annotator 206 may label a person's name in the unstructured data as “P” (short for person) while another annotator 206 may label the name as “PER” and a third annotator 206 may label the name as person. The Entity Disambiguation Module 210 can convert P or PER to PERSON so the different labels used by the NER annotators 206 are harmonized. The leveraged internal knowledge or type specificity information is used for assigning entities, for example, when a mention is assigned to a more specific type (e.g., ORGANIZATION) and to a more general type (e.g., INDUSTRY) the mention is associated with the more specific type. For example, with the mention assigned to ORGANIZATION, and also assigned to INDUSTRY, the Entity Disambiguation Module 210 can convert INDUSTRY to ORGANIZATION, so the different entity types used by the NER annotators 206 are harmonized. The leveraged internal knowledge of length of mention information is used when an extracted entity mention (e.g., COUNTRY) is part of a larger entity mention (e.g., ADDRESS), the mention is associated with the type of the larger mention. The length of mention information is used to convert the entity mention from COUNTRY to the larger entity mention ADDRESS, harmonizing the entity types used by the NER annotators 206.

The Annotation Ranker 212 associates a score to each entity in the set of first resolved entities using information in the knowledge base 208. The Annotation Ranker 212 computes a score for each entity using knowledge base information that can be identified in several manners. For example, the calculation to the score for each entity using information of knowledge base 208 may include the identification of Precision, Recall, F1 metrics for each NER annotator 206 and entity type pair. Precision and Recall are two useful model evaluation metrics where Precision refers to the percentage of the results which are relevant, Recall refers to the percentage of total relevant results correctly classified, and F1 provides a weighted average of the Precision and Recall model evaluation metrics.

The Entity Consolidator 214 resolves the set of first resolved entities to create a set of final entities using the computed score associated to each entity in the set of first resolved entities and information strategies defined by the knowledge base 208. The Entity Consolidator 214 provides the set of final entities to the user via user interface 202. The Entity Consolidator 214 resolves the set of first resolved entities, for example includes the removal of conflicting entity types with lower score by favoring higher scoring entity types, and the removal of entities from associated poorly performed NER annotators e.g., that is performed below a set threshold. For example, Entity Consolidator 214 may identify and remove a conflicting entity type of PERSON for Paris and keep an entity type of CITY for Paris. In other words, one NER annotator 206 may determine the text “Paris” in the unstructured data 202 refers to a person while another NER annotator 206 determines “Paris” refers to the city. The Entity Consolidator 214 determines which of the conflicting entity types to use. In another example, the Entity Consolidator 214 resolves an annotated FIRST NAME/SURNAME of John Doe versus a generic entity type PERSON, with the removal of one selected entity type, such as PERSON based a defined strategy of the knowledge base 208. The set of final entities is applied to the user interface 202. A user can provide feedback relating to the set of final entities that is applied to a Learning Module 220, which integrates the user feedback. For example, the user feedback includes but not limited to missing and misclassified entities in the system output of the set of final entities. Learning Module 220 automatically processes the received user feedback information, automatically updating information in the knowledge base 208. The Learning Module 220 enhances the knowledge base 208 including the information used in the operations performed by the Entity Disambiguation Module 210, Annotation Ranker 212, and Entity Consolidator 214.

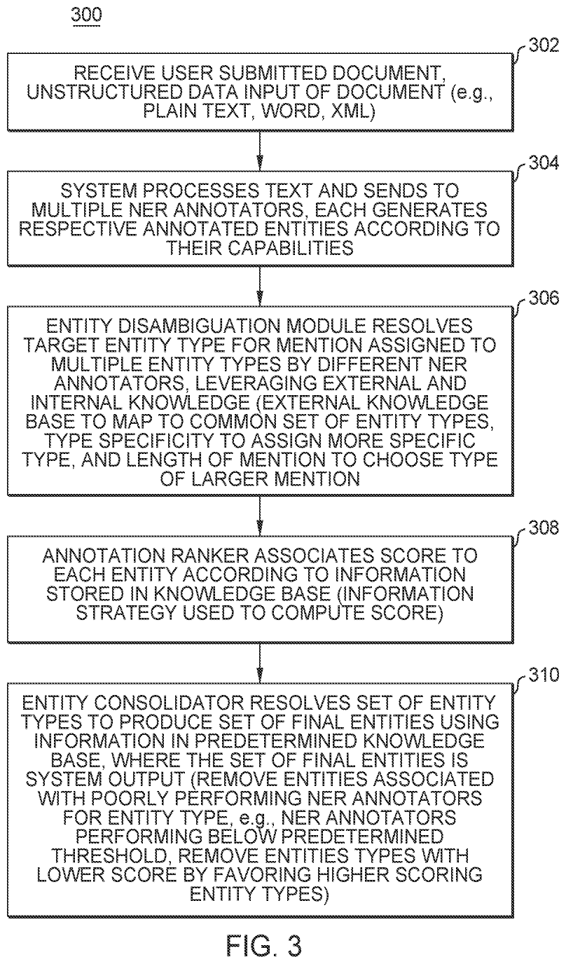

FIG. 3 is a flow chart illustrating example operations of a computer-implemented method 300 of one or more embodiments of data-driven named entity type disambiguation. Method 300 may be implemented with computer 101 for example, together with the Data-Driven Named Entity Type Disambiguation Logic 182 of FIG. 1 to provide an example computer control for operations performed by the referenced software or firmware objects of system 200 of the disclosed embodiments.

In FIG. 3 at block 302, a user submitted document to the system 200 containing unstructured data is received, for example, a Word document, text document or Extensible Markup Language (XML) document. At block 304, the query multiplexer 204 receives and processes the user-entered document, sends a compatible input of the user-entered document to each of the multiple NER annotators 206, #1-3. The knowledge base 208 provides controls and rules for operation of the NER annotators 206, #1-3. At block 304 each of the multiple NER annotators 206, #1-3 generates annotated entities according to their respective different capabilities, and provides confidence values for the generated annotated entities to the knowledge base 208. NER annotators 206, #1-3 apply their respective annotated entities to Entity Disambiguation Module 210.

At block 306, Entity Disambiguation Module 210 resolves the target entity type when a mention was assigned multiple entity types by different NER annotators 206, #1-3 by, e.g., leveraging both external and internal knowledge. The leveraged external and internal knowledge used to resolve the target entity type can include but is not limited to the knowledge base 208 used to map entities detected by the various NER annotators 206, #1-3 to a common set of entity types. At block 306, the knowledge used to resolve the target entity type includes type specificity that is used to assign the extracted entity mention to a more specific entity type. At block 306, the leveraged knowledge used to resolve the target entity type includes length of mention information used to associate the mention with the type of a larger mention.

At block 308, the Annotation Ranker 212 calculates a score for each entity according to information defining a strategy or rule stored in the knowledge base 208. Various computations and strategies can be used to provide the calculated score at block 308, including the identification of Precision, Recall, and F1 metrics for each NER annotator and entity type pair.

At block 310, the Entity Consolidator 214 resolves the final entities produced by the system 100 according to the strategies defined by the knowledge base 208. These strategies can include the removal of conflicting entity types with lower score by favoring higher scoring entity types, the removal of entities for associated NER annotators 206 performing below a set threshold for entity type, and the like. The set of final entities is provided to the user interface 202. The user optionally provides feedback upon review of the final entities. For example, the user feedback comprises information identifying missed and incorrectly classified entities.

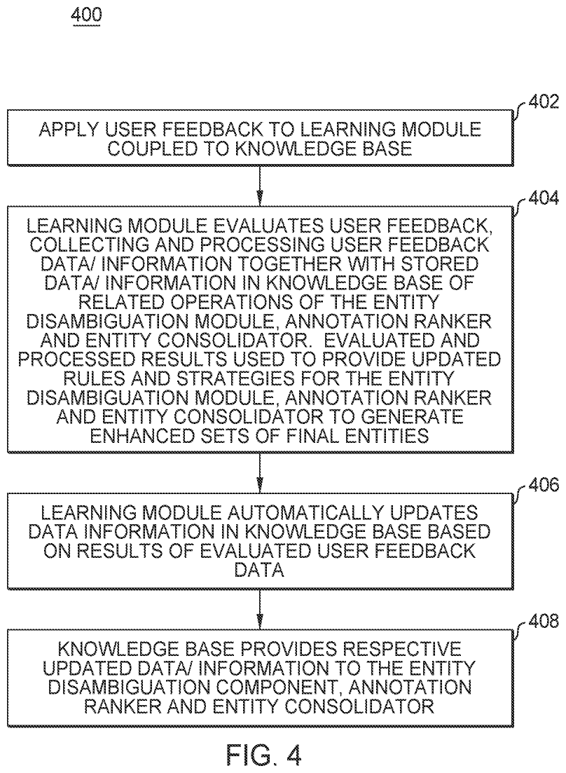

Referring to FIG. 4, example system operations responsive to user feedback of a method 400 are shown of one or more embodiments of data-driven named entity type disambiguation. At block 402, the received user feedback is applied to a Learning Module 220. The Learning Module 220 is coupled to the knowledge base 208 and integrates the feedback provided by the user with the knowledge base. The received user feedback includes, for example missing and misclassified entities in the set of final entities.

At block 404, the Learning Module 220 evaluates the user feedback, collecting and processing the user feedback data/information together with stored data/information in the knowledge base 208 of related system operations resulting in the generated set of final entities with the missed and misclassified entities to provide updated rules and strategies to generate enhanced sets of final entities. At block 406, the Learning Module 220 is a machine learning component that automatically updates information in the knowledge base 208 based upon processing and evaluating the received user feedback, operations of NER annotators 206, #1-3, and operations performed by the Entity Disambiguation Module 210, Annotation Ranker 212, and Entity Consolidator 214 that resulted in the user feedback data. For example, the Learning Module 220 can use the entities detected by each of the multiple NER annotators 206, #1-3 and can determine whether any of the missing and misclassified entities in the set of final entities were correctly detected by any the NER annotators 206, #1-3 and were removed in further processing the annotated entities of the NER annotators. The Learning Module 220 can provide enhanced updated information used by various ones of NER annotators 206, #1-3 to enable generating improved sets of final entities. The Learning Module 220 can evaluate operations performed by the Entity Disambiguation Module 210, Annotation Ranker 212, and Entity Consolidator 214 also to enable generating improved sets of final entities based on the user feedback of missing and misclassified entities. The Learning Module 220 enhances the knowledge base 208 and enables enhanced, updated information to be provided to Entity Disambiguation Module 210, Annotation Ranker 212, and Entity Consolidator 214 at block 406. At block 408, the knowledge base 208 can provide respective updated information used to control the operations performed by one or more of the Entity Disambiguation Module 210, Annotation Ranker 212, and Entity Consolidator 214.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a document containing unstructured data;
analyzing the document using a set of Named Entity Recognition (NER) annotators, each generating annotated entities according to their respective different capabilities;
resolving, for a respective annotated entity, a target entity type when a mention was assigned different entity types by different ones of the NER annotators to form a set of first resolved entities;
associating a computed score to each entity in the set of first resolved entities using information in a knowledge base; and
resolving the set of first resolved entities using the associated computed score for each entity and the information in the knowledge base to create a set of final entities.

2. The method of claim 1, further comprising:
providing the set of final entities to a user; and processing received user feedback information relating to the set of final entities to automatically update information in the knowledge base.

3. The method of claim 2, wherein the received user feedback information relating to the set of final entities comprises information identifying missed and incorrectly classified entities.

4. The method of claim 2, wherein processing received user feedback information comprising updating the information in the knowledge base provided to an Annotation Ranker and provided to an Entity Consolidator.

5. The method of claim 1, wherein resolving, for a respective annotated entity, a target entity type comprises leveraging information of the knowledge base to map entities detected by the different NER annotators to a common set of entity types to form the set of first resolved entities.

6. The method of claim 1, wherein resolving, for a respective annotated entity, a target entity type comprises leveraging a type specificity associated with a respective mention to form the set of first resolved entities.

7. The method of claim 1, wherein resolving, for a respective annotated entity, a target entity type comprises leveraging a length of a respective mention to form the set of first resolved entities.

8. The method of claim 1, wherein the knowledge base contains a semantic specification of the capabilities of each of the NER annotators, and a set of weights associated to each entity and NER annotator pair.

9. The method of claim 1, wherein the knowledge base contains a semantic hierarchy representing semantic relationship among multiple entity types and domain knowledge used to automatically identify characteristics of multiple entity types.

10. The method of claim 1, wherein resolving the set of first resolved entities to create a set of final entities comprises removal of conflicting entity types with a lower score by favoring higher scoring entity types.

11. A system, comprising:
a processor; and
a memory, wherein the memory includes a computer program product configured to perform data-driven named entity type disambiguation, the operations comprising:
receiving a document containing unstructured data;
analyzing the document using a set of Named Entity Recognition (NER) annotators, each generating annotated entities according to their respective different capabilities;
resolving, for a respective annotated entity, a target entity type when a mention was assigned different entity types by different ones of the NER annotators to form a set of first resolved entities;
associating a computed score to each entity in the set of first resolved entities using information in a knowledge base; and
resolving the set of first resolved entities using the associated computed score for each entity and the information in the knowledge base to create a set of final entities.

12. The system of claim 11, further comprising:
providing the set of final entities to a user; and processing received user feedback information relating to the set of final entities to automatically update information in the knowledge base.

13. The system of claim 11, wherein the received user feedback information relating to the set of final entities comprises information identifying missed and incorrectly classified entities; and wherein processing received user feedback information comprising updating the information in the knowledge base provided to an Annotation Ranker and an Entity Consolidator.

14. The system of claim 11, wherein resolving, for a respective annotated entity, a target entity type comprises leveraging information of the knowledge base to map entities detected by the different NER annotators to a common set of entity types to form the set of first resolved entities.

15. The system of claim 11, wherein the knowledge base contains a semantic hierarchy representing semantic relationship among multiple entity types and domain knowledge used to automatically identify characteristics of multiple entity types.

16. A computer program product for data-driven named entity type disambiguation, the computer program product comprising:
a computer-readable storage medium having computer-readable program code embodied therewith, the computer-readable program code executable by one or more computer processors to perform an operation comprising:
receiving a document containing unstructured data;
analyzing the document using a set of Named Entity Recognition (NER) annotators, each generating annotated entities according to their respective different capabilities;
resolving, for a respective annotated entity, a target entity type when a mention was assigned different entity types by different ones of the NER annotators to form a set of first resolved entities;
associating a computed score to each entity in the set of first resolved entities using information in a knowledge base; and
resolving the set of first resolved entities using the associated computed score for each entity and the information in the knowledge base to create a set of final entities.

17. The computer program product of claim 16, wherein the computer-readable program code is further executable to:
provide the set of final entities to a user; and process received user feedback information relating to the set of final entities to automatically update information in the knowledge base.

18. The computer program product of claim 16, wherein the knowledge base contains a semantic hierarchy representing semantic relationship among multiple entity types and domain knowledge used to automatically identify characteristics of multiple entity types.

19. The computer program product of claim 16, wherein resolving, for a respective annotated entity, a target entity type comprises leveraging information of the knowledge base to map entities detected by the different NER annotators to a common set of entity types to form the set of first resolved entities.

20. The computer program product of claim 16, wherein resolving the set of first resolved entities to create a set of final entities comprises removal of conflicting entity types with lower score by favoring higher scoring entity types.
